(19) United States
(12) Patent Application Publication
(10) Pub. No.: US 2026/0095857 A1
(43) Pub. Date: Apr. 2, 2026

(54) Selective Listening with Matter over Wi-Fi

(71) Applicant: Silicon Laboratories Inc., Austin, TX (US)

(72) Inventors: Mathieu Kardous, Montreal (CA); Junior Martinez, Saint-Lazare (CA); Etienne Campeau, Montreal (CA); Louis-Philip Beliveau, Montreal (CA); Jean-Francois Penven, Saint-Basile-le-Grand (CA); Ricardo Casallas, Montreal (CA)

(21) Appl. No.: 18/904,994

(22) Filed: Oct. 2, 2024

(51) Int. Cl. H04W 52/02

(52) U.S. Cl. CPC H04W 52/0216; H04W 52/0261

(57) ABSTRACT

A low power Wi-Fi device that executes the Matter protocol is disclosed. The Wi-Fi device changes its mode of operation based on the status of the Matter protocol. The device monitors the state of Matter subscriptions. Until one or more subscriptions are established, the low power Wi-Fi device operates in DTIM mode, wherein the device wakes for every DTIM beacon. Once a subscription is established, the low power Wi-Fi device operates in Listening Interval mode, wherein the device wakes once per listening interval. The listening interval is a multiple of the beacon interval and is greater than the DTIM beacon interval. This transition reduces the power consumption of the device.

### FIELD

This disclosure describes a system and various methods to reduce power consumption for devices executing the Matter protocol over a Wi-Fi network.

### BACKGROUND

The Wi-Fi protocol was originally designed to include devices which have access to unlimited power. Thus, early revisions of the specification did not include any provisions to support low power devices, which need to enter low power modes in order to conserve battery life. For example, some devices, such as sensor devices, should ideally have a battery life that is more than one year.

More recently, the Wi-Fi protocol has been updated to include some power saving modes of operation. For example, one such update is the inclusion of PS-Poll. In this mode, the low power Wi-Fi device notifies the access point that it is entering a sleep mode. The access point will then buffer all outbound messages for this low power Wi-Fi node. If it has any outbound packets for this device, it indicates this in its beacon message using a TIM (Traffic Indication Map) field. After waking, the low power Wi-Fi device checks the beacon message and if there are stored messages, it transmits a packet to the access point requesting the stored packets.

Matter is a protocol that seeks to standardize the operation of devices, over different interfaces, such as Thread and Wi-Fi.

Issues such as discovery of new devices and interactions between devices are defined by the Matter Software Development Kit (SDK). One such interaction is referred to as subscription, wherein the client receives periodic updates from the Matter End device.

In a Wi-Fi network, in order for a new device to be discovered by a Matter Controller, it needs to receive and process broadcast messages that are sent by the Matter Controller and are forwarded by the Access Point. Specifically, as shown in FIG. 1, the Access Point periodically transmits a beacon message. These beacon messages are transmitted every beacon interval, which is typically 100 milliseconds. Further, these beacon messages include the TIM field described above, which informs each connected device if there are any unicast messages pending for that device. Additionally, every N beacon messages is a DTIM beacon message. DTIM refers to “Delivery Traffic Indication Message”. DTIM beacon messages are delivered every Nth beacon, wherein N is between 1 and 3. In FIG. 1, N is set to 3. The time between DTIM beacon messages may be referred to as a DTIM beacon interval. The DTIM beacon includes the TIM field described above. However, following a DTIM beacon, the Access Point may transmit one or more multicast or broadcast messages.

These broadcast messages are used to discover new devices. Thus, when a new device is first powered on in a new environment, it must listen for these DTIM beacons and subsequent broadcast messages in order to successfully be discovered, and for a subscription to be established.

Guaranteeing receipt of these broadcast messages requires the new device to wake every beacon interval, receive the beacon, receive any subsequent broadcast messages, and process those broadcast messages.

While necessary, this sequence is rather power consuming. Thus, low power devices, such as, for example, door locks which are battery powered, may have limited battery life.

Therefore, it would be beneficial if there were a system and method that allows a Wi-Fi device to be discovered and subscribed to a Matter controller, while limiting the power consumption of that Wi-Fi device.

### SUMMARY

A low power Wi-Fi device that executes the Matter protocol is disclosed. The Wi-Fi device changes its mode of operation based on the status of the Matter protocol. The device monitors the state of Matter subscriptions. Until one or more subscriptions are established, the low power Wi-Fi device operates in DTIM mode, wherein the device wakes for every DTIM beacon. Once a subscription is established, the low power Wi-Fi device operates in Listening Interval mode, wherein the device wakes once per listening interval. The listening interval is a multiple of the beacon interval and is greater than the DTIM beacon interval. This transition reduces the power consumption of the device.

According to one embodiment, a method of operating a low power Wi-Fi device that is executing a Matter protocol is disclosed. The method comprises initializing the low power Wi-Fi device in a first mode; and switching to a second lower power mode when a subscription has been established between the low power Wi-Fi device and a Matter Controller. In some embodiments, the method further comprises returning to the first mode from the second lower power mode when the subscription is terminated. In some embodiments, in the first mode, the low power Wi-Fi device wakes for every “Delivery Traffic Indication Message” (DTIM) beacon. In certain embodiments, in the first mode, the low power Wi-Fi device processes broadcast messages that follow the DTIM beacon. In some embodiments, in the second lower power mode, the low power Wi-Fi device wakes once per listening interval, wherein the listening interval is longer than a duration between DTIM beacons. In certain embodiments, in the second lower power mode, the low power Wi-Fi device does not process broadcast messages that follow the DTIM beacon. In some embodiments, the second lower power mode comprises two substates, a first substate wherein the low power Wi-Fi device wakes once per listening interval, wherein the listening interval is negotiated with an access point, and a second substate wherein the low power Wi-Fi device wakes more frequently than the negotiated listening interval. In certain embodiments, an activity level of the low power Wi-Fi device determines which substate is used. In some embodiments, a power consumption in the second lower power mode is less than 20% of the power consumption in the first mode.

According to another embodiment, a low power Wi-Fi device is disclosed. The low power Wi-Fi device comprises a Wi-Fi network interface; a processing unit; and a memory device in communication with the processing unit comprising instructions, which when executed by the processing unit, enable the low power Wi-Fi device to: initialize in a first mode; and switch to a second lower power mode when a subscription has been established between the low power Wi-Fi device and a Matter Controller. In some embodiments, the memory device further comprises instructions, which when executed by the processing unit, enable the low power Wi-Fi device to return to the first mode from the second lower power mode when the subscription is terminated. In some embodiments, in the first mode, the low power Wi-Fi device wakes for every “Delivery Traffic Indication Message” (DTIM) beacon. In certain embodiments, in the first mode, the low power Wi-Fi device processes broadcast messages that follow the DTIM beacon. In some embodiments, in the second lower power mode, the low power Wi-Fi device wakes once per listening interval, wherein the listening interval is longer than a duration between DTIM beacons. In certain embodiments, in the second lower power mode, the low power Wi-Fi device does not process broadcast messages that follow the DTIM beacon. In some embodiments, the second lower power mode comprises two substates, a first substate wherein the low power Wi-Fi device wakes once per listening interval, wherein the listening interval is negotiated with an access point, and a second substate wherein the low power Wi-Fi device wakes more frequently than the negotiated listening interval. In certain embodiments, an activity level of the low power Wi-Fi device determines which substate is used. In some embodiments, a power consumption of the low power Wi-Fi device in the second lower power mode is less than 20% of the power consumption in the first mode.

### BRIEF DESCRIPTION OF THE DRAWINGS

For a better understanding of the present disclosure, reference is made to the accompanying drawings, in which like elements are referenced with like numerals, and in which:

FIG. 1 shows a timing diagram showing traffic generated by the access point;

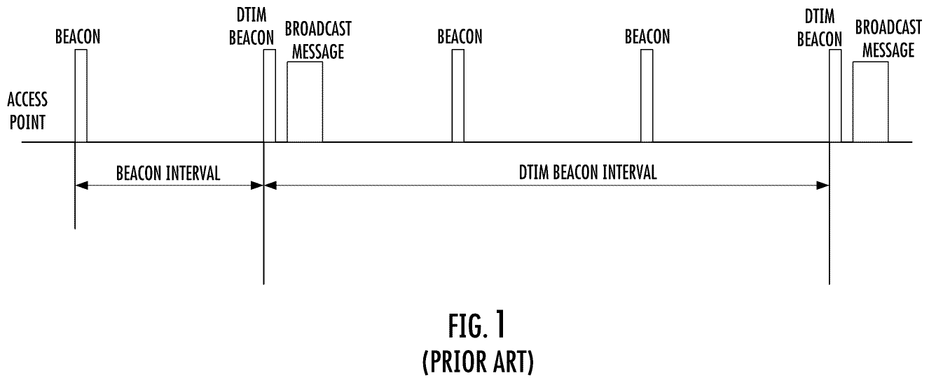

FIG. 2 shows a block diagram of a Wi-Fi network device;

FIG. 3 shows a Wi-Fi network with a Matter Controller, a Wi-Fi access point, a low power Wi-Fi device and a mobile device;

FIG. 4 shows the software architecture of the low power Wi-Fi device;

FIG. 5 shows the operation of the low power Wi-Fi device according to one embodiment; and

FIG. 6 shows the operation of the low power Wi-Fi device according to a second embodiment.

### DETAILED DESCRIPTION

This disclosure presents a system and method that describes techniques to reduce power consumption when executing the Matter protocol over Wi-Fi.

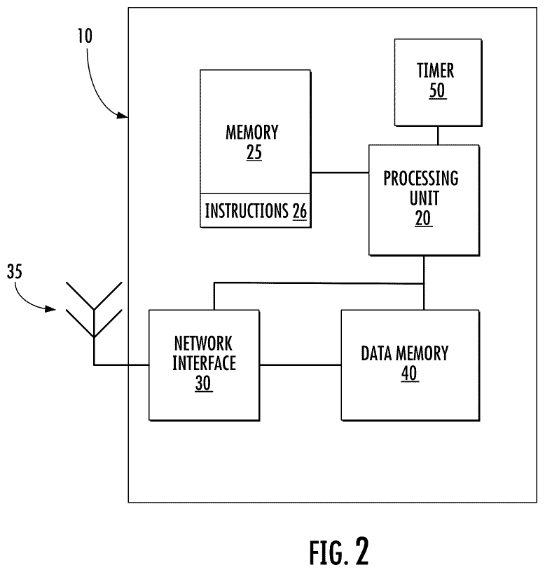

FIG. 2 shows a block diagram of a representative Wi-Fi device 10 that may be used to implement the disclosed method of minimizing power consumption in a Wi-Fi device.

The Wi-Fi device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the Wi-Fi device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 2. The second computer readable non-transitory media may be a CDROM, or a different memory device, which is located remote from the Wi-Fi device 10. The instructions contained on this second computer readable non-transitory media may be downloaded onto the memory device 25 to allow execution of the instructions by the Wi-Fi device 10.

The Wi-Fi device 10 also includes a Wi-Fi network interface 30 that connects with a Wi-Fi network using an antenna 35.

The Wi-Fi device 10 may include a data memory device 40 in which data that is received and transmitted by the Wi-Fi network interface 30 is stored. This data memory device 40 is traditionally a volatile memory. The processing unit 20 has the ability to read and write the data memory device 40 so as to communicate with the other devices in the Wi-Fi network.

Although not shown, the Wi-Fi device 10 also has a power supply, which may be a battery.

While the processing unit 20, the memory device 25, the Wi-Fi network interface 30, and the data memory device 40 are shown in FIG. 2 as separate components, it is understood that some or all of these components may be integrated into a single electronic component. Rather, FIG. 2 is used to illustrate the functionality of the Wi-Fi device 10, not its physical configuration.

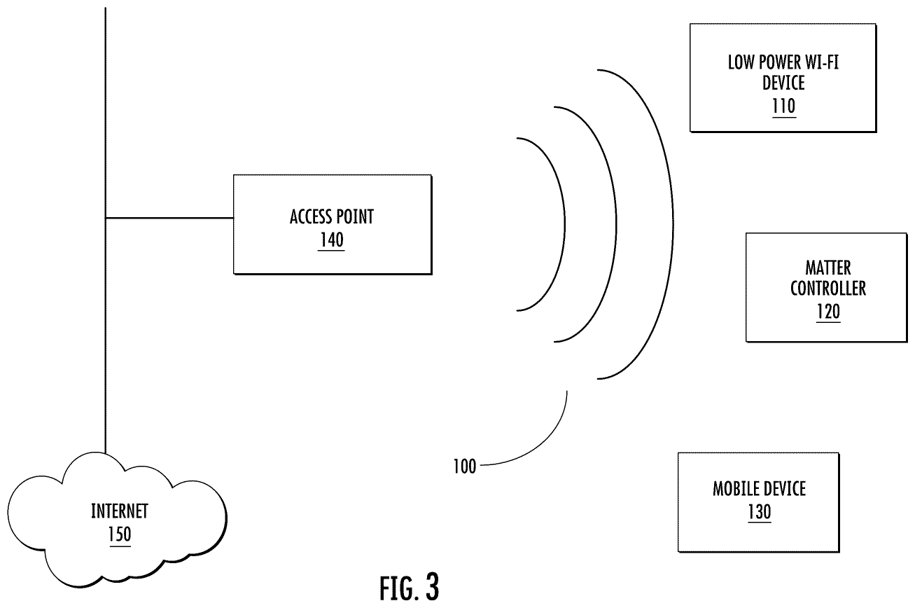

FIG. 3 shows a home network 100 that utilizes Wi-Fi. The home network 100 includes a low power Wi-Fi device 110 and a Matter Controller 120. The Matter Controller 120 may be any suitable device, such as a Google Nest Hub, Apple HomePod, Samsung SmartThings and others. The home network 100 also includes a Wi-Fi access point 140. In certain embodiments, the Matter Controller 120 may be the Wi-Fi access point. The Wi-Fi access point 140 may have access to the internet 150. The home network 100 may also include a mobile device 130, such as a mobile telephone. The mobile device 130 may also implement Matter over Wi-Fi as well. As an example, an application may be present on the mobile device 130 that allows the user to control a device within the home network, such as low power Wi-Fi device 110. The mobile device 130 may wish the temperature of the room to be modified. The mobile device 130 transmits the request to the Matter Controller 120 via the Wi-Fi access point 140. The Matter Controller 120 then transmits a command to the thermostat via the Wi-Fi access point 140. In the next beacon message sent by the Wi-Fi access point 140, the bit in the TIM field associated with the thermostat is set, which may be low power Wi-Fi device 110. The next time that the low power Wi-Fi device 110 receives a beacon message, it detects that the Wi-Fi Access Point 140 has a unicast message for it. It then receives the message, and adjusts the temperature accordingly. As another embodiment, the low power Wi-Fi device 110 may be a door lock, and the mobile device 130 may wish that the door be unlocked. That operation would follow the sequence described above. Note that in embodiments where the Matter Controller 120 is separate from the Wi-Fi access point 140, all communications between the Matter Controller 120 and the low power Wi-Fi device 110 pass through the Wi-Fi access point 140.

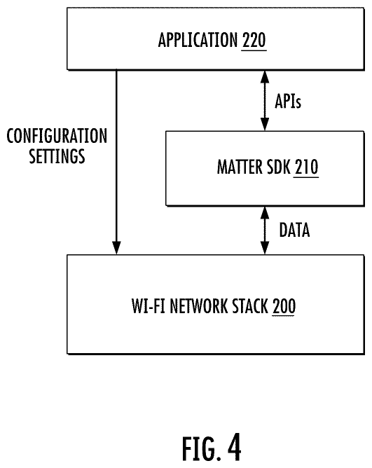

FIG. 4 shows the software architecture of the low power Wi-Fi device. At the lowest level is the Wi-Fi network stack 200. This Wi-Fi network stack 200 is responsible for implementing the physical and link layer protocols associated with Wi-Fi. Disposed above the Wi-Fi network stack is the Matter software development kit (SDK) 210. The Matter SDK 210 provides the services and applications needed to implement a Wi-Fi device that is Matter compatible. Note that the interaction between the Matter SDK 210 and the Wi-Fi network stack 200 may comprise the transfer of data. Specifically, data to be transmitted is supplied from the Matter SDK 210 to the Wi-Fi network stack 200 and data that is received is supplied from the Wi-Fi network stack 200 to the Matter SDK 210. Disposed at the highest level is the application 220. The application 220 communicates with the Matter SDK 210 using APIs (application programming interfaces). Further, the application 220 may communicate directly with the Wi-Fi network stack 200 to provide configuration settings.

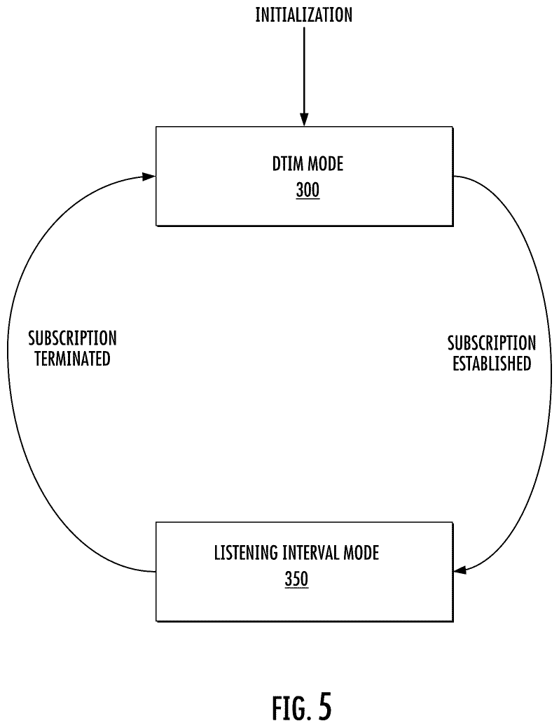

As noted above, to successfully be discovered and subscribed, the low power Wi-Fi device must listen to every DTIM beacon and associated subsequent broadcast message. If the DTIM period is set to one, the low power Wi-Fi device 110 must wake every 100 milliseconds. Thus, at initialization, the application 220 sets the mode of the Wi-Fi network stack 200 to a first mode, wherein the low power Wi-Fi device wakes for every DTIM beacon message. This is shown in FIG. 5. This first mode is referred to as DTIM mode 300. However, note that waking for each DTIM beacon and processing every broadcast message has a significant impact on power consumption.

It has been found that, once a low power Wi-Fi device has been discovered and successfully subscribed, there are few, if any, scenarios where that low power Wi-Fi device needs to listen to or process broadcast messages. Thus, as shown in FIG. 5, after a subscription has been established, the low power Wi-Fi device 110 may enter a second lower power state, referred to as the Listening Interval mode 310. In the Listening Interval mode, the low power Wi-Fi device 110 does not wake up for every DTIM beacon message. Rather, it wakes once per listening interval. The maximum listening interval is established between the Wi-Fi access point 140 and the low power Wi-Fi device 110 when an association is made between the low power Wi-Fi device 110 and the Wi-Fi access point 140. This listening interval indicates the maximum amount of time that the low power Wi-Fi device 110 may be asleep, unable to receive any beacons or broadcast messages. The listening interval is defined as a negotiated number of beacon intervals. This negotiated number may be in excess of 10. For example, a listening interval of 10 beacon intervals indicates that the low power Wi-Fi device 110 will wake once every second. Note that the value of the listening interval is not limited by this disclosure.

Thus, in one embodiment, the application 220 queries the Matter SDK 210 to determine whether a subscription has been established. Once the Matter SDK 210 verifies that a subscription has indeed been established, the application 220 changes the configuration settings for the Wi-Fi network stack 200. This modifies the mode of operation to the listening interval mode 310.

Further, in some embodiments, the subscription may be terminated. For example, the Matter Controller 120 may have a software update or have been replaced. In this case, the Matter SDK 210 may note that the subscription to the Matter Controller 120 has been lost. For example, the low power Wi-Fi device 110 may track the elapsed time since the last communication from the Matter Controller 120. If that elapsed time exceeds a predetermined value, it may be assumed that the Matter Controller 120 is no longer present. In this scenario, the application 220 realizes that a new discovery process will likely occur soon and therefore, reverts back to the DTIM mode 300.

Note that as a further reduction in power consumption, the application 220 may also cause the low power Wi-Fi device 110 to enable broadcast filtering, which indicates that the low power Wi-Fi device 110 will not process any broadcast messages that are received after the DTIM beacon. Thus, the low power Wi-Fi device 10 may wake once per listening interval, receive the beacon, and check if its TIM bit is set. It may then ignore any subsequent broadcast messages.

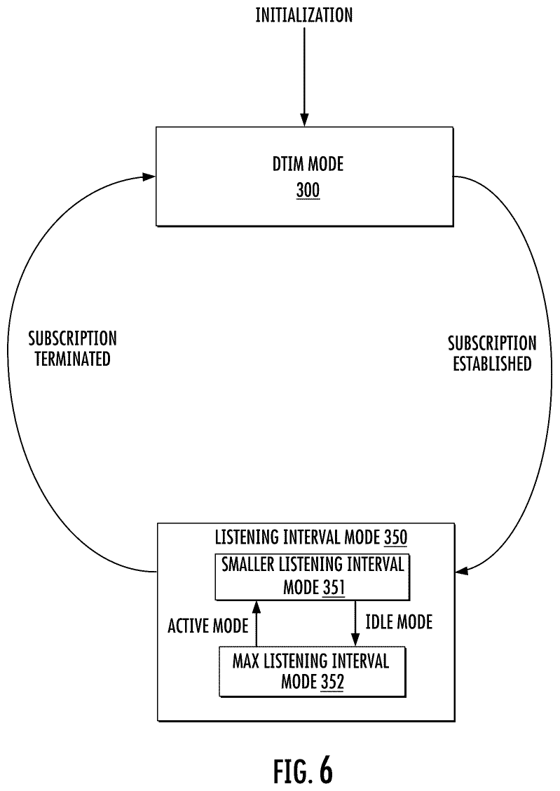

In another embodiment, the low power Wi-Fi device 110 may include two sub-states in the Listening Interval mode 350. This configuration is shown in FIG. 6. The Matter SDK 210 tracks the activity level of the Matter connection. The application then queries the Matter SDK 210 to learn the activity level. If the Matter SDK 210 indicates that the low power Wi-Fi device 110 is in active mode, the application 220 may adjust the listening interval used by the Wi-Fi network stack 200. Specifically, in active mode, the listening interval may be set to a value that is smaller than the negotiated listening interval, referred to as Smaller Listening Interval mode 351. This may improve response time and reduce latency while minimally increasing power consumption. This smaller listening interval may still be longer than the duration between consecutive DTIM beacons. Additionally, when the Matter SDK 210 indicates that the low power Wi-Fi device is in idle mode, the application 220 may adjust the listening interval used by the Wi-Fi network stack 200 by modifying the listening interval to the negotiated value. This is referred to as Max Listening Interval mode 352.

Further, there are some other variations of these sequences. For example, in certain embodiments, the low power Wi-Fi device 110 may be aware that there will be more than one subscription. For example, the low power Wi-Fi device 110 may have several different functions, and there may be a subscription for each of these functions. In this scenario, the low power Wi-Fi device 110 does not transition to the Listening Interval mode 350 until all of the expected subscriptions have been established.

This system and method has many advantages. For example, in one test, the low power Wi-Fi device 110 was used in default mode, in which the low power Wi-Fi device remains in the DTIM mode 300 at all times. The average power consumption in this default mode was about 2.5 mA in a noisy environment. The low power Wi-Fi device 110 was then configured to operate using the sequence shown in FIG. 5. When the listening interval was set to 1 second (10 beacon intervals), the average power consumption was about 438 μA in a noisy environment. The device was then modified to enable broadcast filtering so that any broadcast messages were not processed. This further reduced the power consumption to about 340 μA in a noisy environment. Increasing the listening interval to 2 seconds (20 beacon intervals) reduced the power consumption to about 290 μA. Enabling broadcast filtering reduced the power consumption further to about 270 μA. Note that the power consumption in the Listening Interval mode may be less than 20% of the power consumption in the default (DTIM mode) described above. These average power consumption values may be further decreased by increasing the listening interval to 3 seconds.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of operating a low power Wi-Fi device that is executing a Matter protocol, comprising:
initializing the low power Wi-Fi device in a first mode; and
switching to a second lower power mode when a subscription has been established between the low power Wi-Fi device and a Matter Controller.

2. The method of claim 1, further comprising returning to the first mode from the second lower power mode when the subscription is terminated.

3. The method of claim 1, wherein in the first mode, the low power Wi-Fi device wakes for every “Delivery Traffic Indication Message” (DTIM) beacon.

4. The method of claim 3, wherein in the first mode, the low power Wi-Fi device processes broadcast messages that follow the DTIM beacon.

5. The method of claim 1, wherein in the second lower power mode, the low power Wi-Fi device wakes once per listening interval, wherein the listening interval is longer than a duration between DTIM beacons.

6. The method of claim 5, wherein in the second lower power mode, the low power Wi-Fi device does not process broadcast messages that follow the DTIM beacon.

7. The method of claim 1, wherein the second lower power mode comprises two substates, a first substate wherein the low power Wi-Fi device wakes once per listening interval, wherein the listening interval is negotiated with an access point, and a second substate wherein the low power Wi-Fi device wakes more frequently than the negotiated listening interval.

8. The method of claim 7, wherein an activity level of the low power Wi-Fi device determines which substate is used.

9. The method of claim 1, wherein a power consumption in the second lower power mode is less than 20% of the power consumption in the first mode.

10. A low power Wi-Fi device, comprising:
a Wi-Fi network interface;
a processing unit; and
a memory device in communication with the processing unit comprising instructions, which when executed by the processing unit, enable the low power Wi-Fi device to:
initialize in a first mode; and
switch to a second lower power mode when a subscription has been established between the low power Wi-Fi device and a Matter Controller.

11. The low power Wi-Fi device of claim 10, wherein the memory device further comprises instructions, which when executed by the processing unit, enable the low power Wi-Fi device to return to the first mode from the second lower power mode when the subscription is terminated.

12. The low power Wi-Fi device of claim 10, wherein in the first mode, the low power Wi-Fi device wakes for every “Delivery Traffic Indication Message” (DTIM) beacon.

13. The low power Wi-Fi device of claim 12, wherein in the first mode, the low power Wi-Fi device processes broadcast messages that follow the DTIM beacon.

14. The low power Wi-Fi device of claim 10, wherein in the second lower power mode, the low power Wi-Fi device wakes once per listening interval, wherein the listening interval is longer than a duration between DTIM beacons.

15. The low power Wi-Fi device of claim 14, wherein in the second lower power mode, the low power Wi-Fi device does not process broadcast messages that follow the DTIM beacon.

16. The low power Wi-Fi device of claim 10, wherein the second lower power mode comprises two substates, a first substate wherein the low power Wi-Fi device wakes once per listening interval, wherein the listening interval is negotiated with an access point, and a second substate wherein the low power Wi-Fi device wakes more frequently than the negotiated listening interval.

17. The low power Wi-Fi device of claim 16, wherein an activity level of the low power Wi-Fi device determines which substate is used.

18. The low power Wi-Fi device of claim 10, wherein a power consumption of the low power Wi-Fi device in the second lower power mode is less than 20% of the power consumption in the first mode.
